(19) United States
(12) Patent Application Publication
(10) Pub. No.: US 2020/0150570 A1
(43) Pub. Date: May 14, 2020

(54) IMAGE FORMING APPARATUS

(71) Applicant: CANON KABUSHIKI KAISHA, Tokyo (JP)

(72) Inventor: Yutaro Tsuno, Abiko-shi (JP)

(21) Appl. No.: 16/674,295

(22) Filed: Nov. 5, 2019

(30) Foreign Application Priority Data
Nov. 8, 2018 (JP) 2018-210760

(51) Int. Cl. G03G 15/00; B65H 7/02; B65H 5/06; B65H 1/26

(52) U.S. Cl. CPC G03G 15/50; G03G 15/6529; B65H 1/266; B65H 5/062; B65H 7/02

(57) ABSTRACT

An image forming apparatus includes a stacking portion, an image forming portion, an acquiring portion, and an executing portion capable of executing, on the basis of image data acquired by the acquiring portion, an operation in a first image forming mode in which an image is formed on an envelope stacked on the stacking portion in a state in which a flap of the envelope is open. The executing portion forms an image ranging between the flap closed and the non-address side by automatically reversing and feeding the envelope to form an image on the flap on an address side and to form an image on the non-address side.

### FIELD OF THE INVENTION AND RELATED ART

The present invention relates to an image forming apparatus, such as a printer, a copying machine, a facsimile machine or a multi-function machine using an electrophotographic type.

In the image forming apparatus of the electrophotographic type or the like, a toner image is formed on a recording material at a transfer portion and thereafter the recording material is fed to a fixing device in order to fix the toner image on the recording material. When the recording material fed to the fixing device passes through a fixing nip formed by a fixing roller and a pressing roller, the toner image formed on the recording material is fixed on the recording material by being heated and pressed.

In recent years, the image forming apparatus is used for printing an image on, as a recording material, an envelope in addition to sheets such as plain paper, thick paper, rough paper, embossed paper and coated paper (Japanese Laid-Open Patent Application (JP-A) 2007-271681). In the image forming apparatus disclosed in JP-A 2007-271681, a pressure of the fixing nip (nip pressure) is changed between the case where the image is printed on the plain paper and the case where the image is printed on the envelope.

Incidentally, a user intends to perform printing of a character or the like on a flap of the envelope in some cases, and conventionally, the character or the like is printed in a state in which the flap is closed. However, in the case where printing is performed, in the state in which the flap is closed (i.e., during printing of the character or the like on a non-address side), a nip pressure during fixing can different due to a difference in thickness generated between a portion overlapping with the flap closed (hereinafter referred to as a flap portion) and a portion which does not overlap with the flap (hereinafter referred to as a non-flap portion). When the nip difference is different, although depending on a kind of the envelope, there was a liability that improper fixing is liable to occur when printing ranging between the flap portion and the non-flap portion is performed, the printing onto the flap is not properly performed. Therefore, it has been desired that the printing onto the flap of the envelope, particularly the printing ranging between the flap portion and the non-flap portion is capable of being properly performed.

### SUMMARY OF THE INVENTION

A principal object of the present invention is to provide an image forming apparatus capable of properly forming an image on a flap in envelope printing using the image forming apparatus.

According to an aspect of the present invention, there is provided an image forming apparatus comprising: a stacking portion configured to stack an envelope; an image forming portion configured to form a toner image on the envelope fed from the stacking portion; an acquiring portion configured to acquire image data ranging between a flap closed and a non-address side; and an executing portion capable of executing, on the basis of the image data acquired by the acquiring portion, an operation in a first image forming mode in which an image is formed on the envelope stacked on the stacking portion in a state in which the flap is open, wherein the executing portion forms an image ranging between the flap closed and the non-address side by automatically reversing and feeding the envelope to form an image on the flap on an address side and to form an image on the non-address side.

Further features of the present invention will become apparent from the following description of exemplary embodiments with reference to the attached drawings.

### BRIEF DESCRIPTION OF THE DRAWINGS

FIG. 1 is a schematic view showing an image forming apparatus to which a control device in an embodiment is applicable.

FIG. 2 is a schematic view showing a fixing device.

FIG. 3 is a control block diagram for illustrating a controller.

FIG. 4 is a schematic view showing an operating portion.

FIG. 5 is a schematic view showing an input screen.

FIG. 6 is a flowchart showing an envelope printing process.

Parts (a) and (b) of FIG. 7 are schematic views each showing a stacking method of an envelope on a manual feeding tray, in which part (a) shows the case where an image is printed on a flap during address side printing, and part (b) shows the case where the image is printed on the flap during non-address side printing.

FIG. 8 is a flowchart showing a flap printing process.

FIG. 9 is a schematic view showing print states of the envelope in the cases of printing in a state in which the flap is open and in a state in which the flap is closed.

### DESCRIPTION OF EMBODIMENTS

### <Image Forming Apparatus>

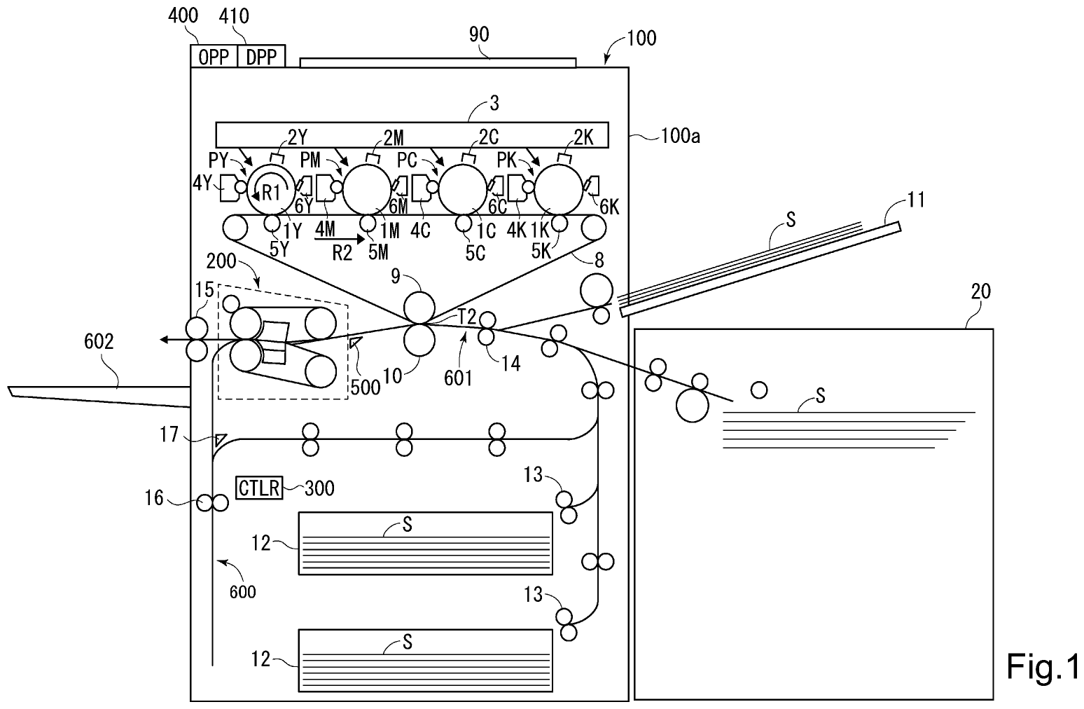

A control device in an embodiment will be described. First, an image forming apparatus of a lateral (horizontal) feeding type to which the control device in this embodiment is applicable will be described using FIG. 1. An image forming apparatus 100 shown in FIG. 1 is a tandem full-color printer of an electrophotographic type. The image forming apparatus 100 includes image forming portions PY, PM, PC and PK for forming images of yellow, magenta, cyan and black, respectively. The image forming apparatus 100 forms a toner image on a recording material depending on image data from an original reading device (not shown) connected to an apparatus main assembly 100a or from an external device, such as a personal computer, communicatably connected to the apparatus main assembly 100a. In this embodiment, the image forming apparatus 100 is capable of forming the toner image on an envelope S which is the recording material.

As shown in FIG. 1, the image forming portions PY, PM, PC and PK are arranged in the apparatus main assembly 100a along a movement direction of an intermediary transfer belt 8. The intermediary transfer belt 8 is stretched by a plurality of rollers and is constituted so as to travel in an arrow R2 direction. The intermediary transfer belt 8 carries and feeds toner images which are primary-transferred thereon. At a position opposing, through the intermediary transfer belt 8, a secondary transfer inner roller 9 for stretching the intermediary transfer belt 8, a secondary transfer outer roller 10 is provided and constitutes a secondary transfer portion T2 where the toner images are transferred from the intermediary transfer belt 8 onto the envelope S. On a side downstream of the secondary transfer portion T2 with respect to a recording material feeding direction, a fixing device 200 is provided. Incidentally, in the case of this embodiment, the image forming portion PY to PK, the intermediary transfer belt 8, a secondary transfer inner roller 9 and the secondary transfer outer roller 10 are an example of an image forming unit capable of forming the toner image on the envelope S.

At a lower portion of the image forming apparatus 100, a cassette 12 in which envelopes S are stacked. Each of the envelopes S is supplied from the cassette 12 to a feeding passage 601 by a feeding roller pair 13. Thereafter, a registration roller pair 14 is started to the rotated in synchronism with the toner images formed on the intermediary transfer belt 8 as described later, whereby the envelope S is fed to the secondary transfer portion T2. Incidentally, the cassette 12 may also be provided in plurality so that envelopes different in size and thickness can be stacked on the plurality of cassettes 12, and in that case, the envelope S is selectively fed from either one of the plurality (two in this embodiment) of cassettes 12. Further, the envelope S is not limited to the envelopes S stacked on the cassettes 12, and the envelope S stacked on a manual feeding tray 11 may also be fed or the envelope S stacked in a stacking device 20 connected to the apparatus main assembly 100a may also be fed. Incidentally, in this embodiment, the envelope S on the manual feeding tray 11 or in the stacking device 11 is fed to the secondary transfer portion T2 while being kept in a stacked state so that the toner image is formed on an upper surface side. On the other hand, the envelope S in the cassette 12 is fed to the secondary transfer portion T2 while being in a stacked state so that the toner image is formed on a lower surface side.

The four image forming portions PY, PM, PC and PK substantially have the same constitution except that development colors are different from each other. Accordingly, in this embodiment, as a representative, the image forming portion PY for yellow will be described, and other image forming portions will be omitted from description. In the image forming portion PY, a photosensitive drum 1Y is provided. The photosensitive drum 1Y is rotationally driven in an arrow R1 direction. At a periphery of the photosensitive drum 1Y, a charging device 2Y, an exposure device 3, a developing device 4Y, a primary transfer roller 5Y and a cleaning device 6Y are provided.

In the case where an image forming operation is started, first, a surface of the rotating photosensitive drum 1Y is electrically charged uniformly by the charging device 2Y. The charging device 2Y is, for example, a corona charger for charging the photosensitive drum 1Y uniformly to a negative dark-portion potential by irradiating the photosensitive drum 1Y with charged particles with corona discharge. Then, the photosensitive drum 1Y is subjected to scanning exposure to laser light, corresponding to image data, emitted from the exposure device 3. As a result, an electrostatic latent image depending on the image data is formed on the surface of the photosensitive drum 1Y. The electrostatic latent image formed on the photosensitive drum 1Y is visualized by toner (developer) accommodated in the developing device 4Y, so that the toner image which is a visible image is formed.

The toner image formed on the photosensitive drum 1Y is primary-transferred onto the intermediary transfer belt 8 at a primary transfer portion formed between the photosensitive drum 1Y and the intermediary transfer belt 8 urged by the primary transfer roller 5Y. At this time, to the primary transfer roller 5Y, a primary transfer bias is applied. The toner remaining on the surface of the photosensitive drum 1Y after the primary transfer is removed by the cleaning device 6Y.

Such an operation is successively performed in the respective image forming portions PY to PK for yellow, magenta, cyan and black, respectively, so that four color toner images are superposed on each other. Therefore, in synchronism with toner image formation, the envelope S stacked on the manual feeding tray 11, the cassette 12 or the stacking device 20 is fed to the secondary transfer portion T2 through the feeding passage 601. Then, by applying a secondary transfer bias to the secondary transfer outer roller 10, a full-color toner image formed on the intermediary transfer belt 8 is secondary-transferred onto the envelope S.

Then, the envelope S passed through the secondary transfer roller T2 is supported by a guiding member 500 and is fed toward a fixing device 200. The guiding member 500 guides the envelope S toward the guiding member 500 while supporting the envelope S on a side opposite from a side where the toner image is formed during passing of the envelope S through the secondary transfer portion T2 immediately before guidance of the envelope S by the guiding member 500. In the fixing device 200 as a fixing portion, the toner image is heated and pressed with nip-feeding of the envelope S, so that the toner image is fixed on the envelope S.

### <Fixing Device>

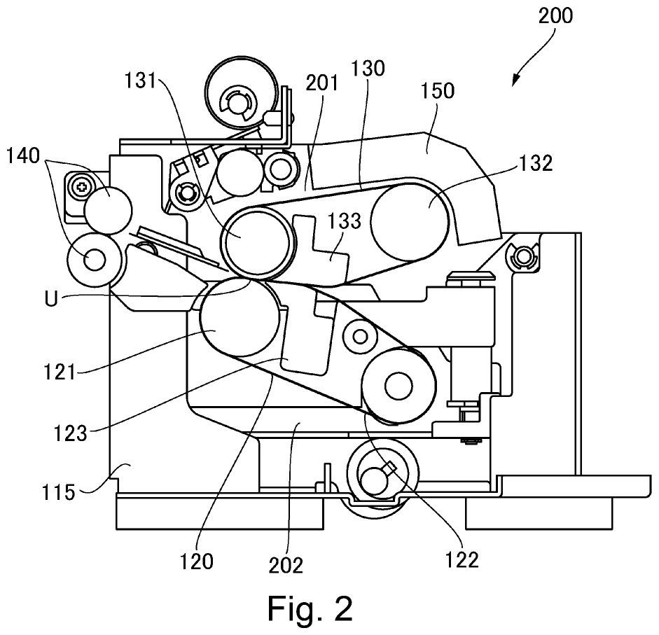

The fixing device 200 will be described using FIG. 2. The fixing device 200 shown in FIG. 2 is a fixing device of a twin belt type. This fixing device 200 forms a fixing nip U by causing an endless pressing belt 120 assembled with a lower frame 202 to be press-contacted to an endless heating belt 130 assembled with an upper frame 201. The heating belt 130 is extended around a driving roller 131 and a tension roller 132, which are shaft-supported by a frame 115, with predetermined tension, and is circulated and rotated by rotation of the driving roller 131. The driving roller 131 has a function of generating pressure at the fixing nip U by supporting an inner surface of the heating belt 130, and the tension roller 132 has a function of imparting belt tension to the heating belt 130. Inside a heating belt 130, a fixing pad 133 formed of stainless steel, for example, is provided. The fixing pad 133 presses the heating belt 130 toward a pressing pad 123 with predetermined pressure, and thus forms the fixing nip U in combination with the driving roller 131.

In the fixing device 200, the heating belt 130 is heated by an induction heating device 150 (for example, an IH heater) through electromagnetic induction heating. The induction heating device 150 is provided so as to provide a predetermined gap between itself and another peripheral surface of the heating belt 130. The induction heating device 150 includes, although omitted from illustration, for example, an exciting coil prepared by winding electric wire such as Litz wire, and an outside magnetic core. The exciting coil generates an AC magnetic field (magnetic flux) when an alternating current is applied thereto. The exciting coil generates the AC magnetic field, so that the heating belt 130 is induction-heated. Further, in order to induction-heat the heating belt 130 efficiently, the outside magnetic are formed with a high-permeability member such as ferrite capable of shielding the AC magnetic field is provided so as to cover the exciting coil.

On the other hand, the pressing belt 120 is extended around a pressing roller 121 shaft-supported by the lower frame 202 and a tension roller 122 with predetermined tension and is rotated by the rotation of the heating belt 130. Inside the pressing belt 120, the pressing pad 123 formed of a silicone rubber, for example, is disposed. The pressing pad 123 presses the pressing belt 120 toward the fixing pad 133 with predetermined pressure, and thus forms the fixing nip U in combination with the pressing roller 121. Then, when the envelope S passes through the fixing nip U, the envelope S is discharged to an outside of the fixing device 200 by a fixing discharging roller pair 140.

Returning to FIG. 1, the image forming apparatus 100 is capable of printing images on both sides (surfaces) of the envelope S. In the case of one-side printing, the envelope S on which the toner image is fixed on one side thereof is discharged by a discharging roller pair 15 on a discharge tray 602 provided outside the apparatus main assembly 100a. On the other hand, in the case of double-side printing, the envelope S on which the toner image is fixed on a first (one) side is fed by a normally rotating feeding roller pair 16 toward a double-side feeding passage 600 in order to form a toner image on a second side subsequently to the fixing of the toner image on the first side. Then, the feeding roller pair 16 is reversely rotated with timing when a trailing end of the envelope S with respect to a recording material (envelope) feeding direction reaches a switching portion 17. Leading and trailing ends of the envelope S are changed to each other in the double-side feeding passage 600 by the reverse rotation of the feeding roller pair 16 and is fed again along the feeding passage 601 toward the registration roller pair 14 (so-called, switch-back feeding). In this case, the envelope S to be fed again along the feeding passage 601 is switched (reversed) between the first side and the second side thereof so that the other side (the second side opposite from the first side) where the toner image is not fixed at the secondary transfer portion T2 faces toward the intermediary transfer belt 8 side. Thereafter, the envelope S is subjected to the process similar to the process in the case of the one-side printing, and thus the toner image is fixed on the second side thereof, and then is discharged by the discharging roller pair 15 on the discharge tray 602 disposed outside the apparatus main assembly 100a. Incidentally, a portion constituted by the double-side feeding passage 600, the discharging roller pair 15 and the switching portion 17 is an example of a feeding mechanism for automatically reversing and feeding the envelope S.

### <Controller>

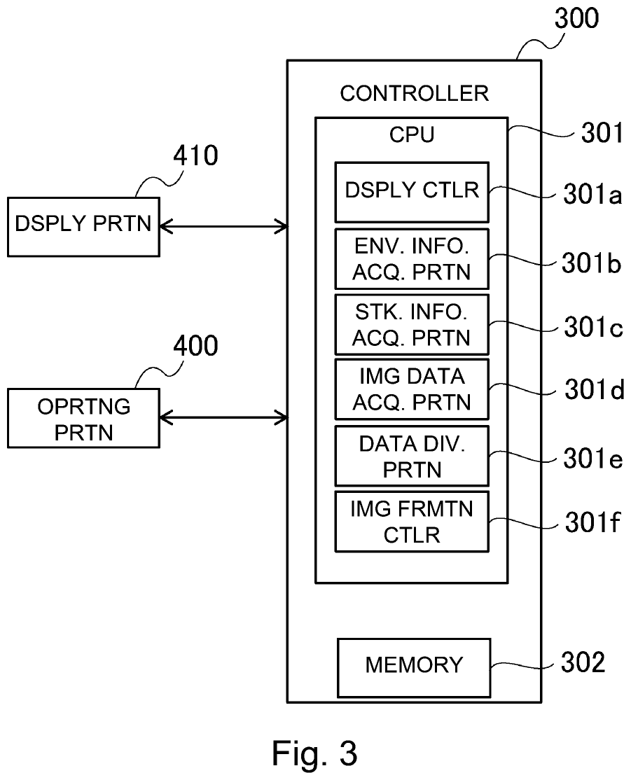

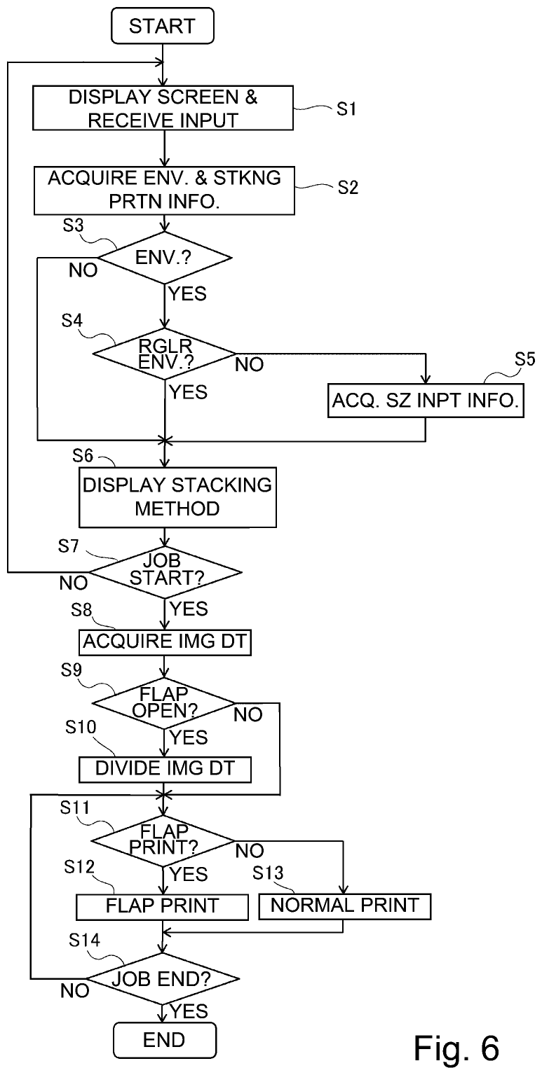

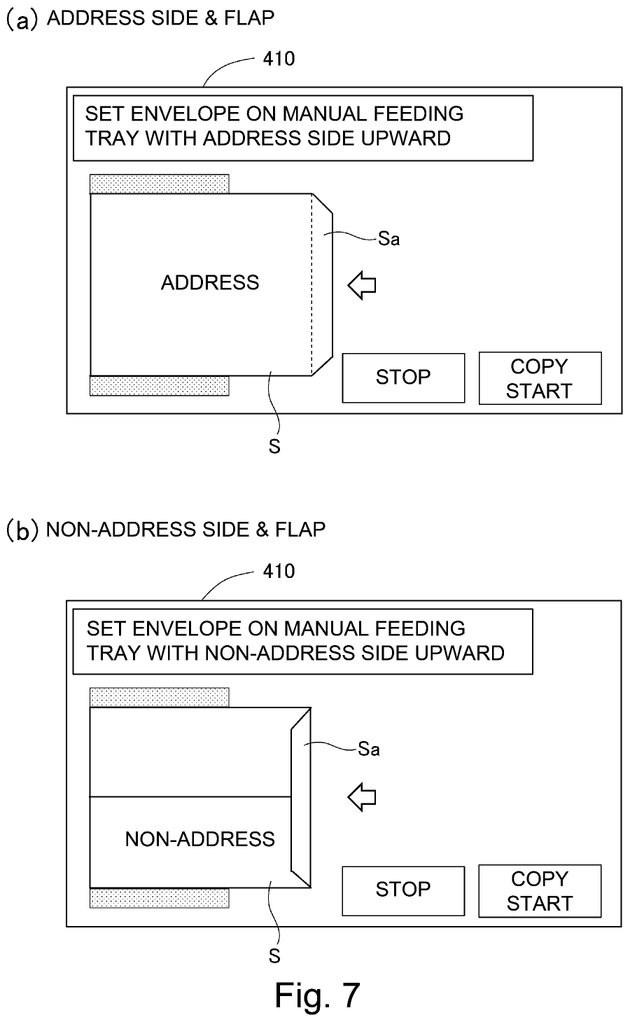

As shown in FIG. 1, the image forming apparatus 100 of this embodiment includes a controller 300 as a controlling device. The controller 300 will be described using FIG. 3. As shown in FIG. 3, the controller 300 includes a CPU 301 (central processing unit) and a memory 302 such as a ROM (read only memory) or a RAM (random access memory). In the memory 302, for example, various programs such as an envelope printing program (FIG. 6 described later) and an image forming job, and various data such as envelope information and stacking portion information which are described later, and the like are capable of being stored. The CPU 301 is capable of executing the various programs stored in the memory 302. Incidentally, the memory 302 is also capable of temporarily storing a calculation process result with execution of the various programs.

In the case of this embodiment, the CPU 301 is capable of carrying out an operation of the image forming apparatus 100 regarding printing on the envelope by executing the envelope printing program in advance of execution of the image forming job. Incidentally, the envelope printing program is not limited to the form of a software program, but may also be executable in the form of a micro program processed by a DSP (digital signal processor), for example. That is, as regards the CPU 301, one for carrying out various pieces of control such as an image forming operation by executing a control program such as the image forming job may also be used in combination, but the CPU 301 is not limited thereto. A CPU prepared exclusively for executing the envelope printing program may also be used.

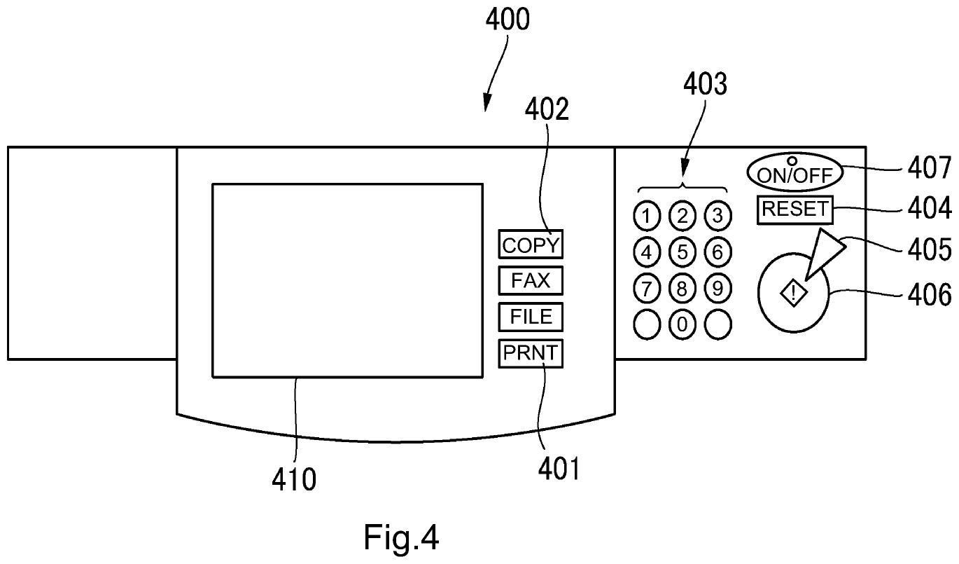

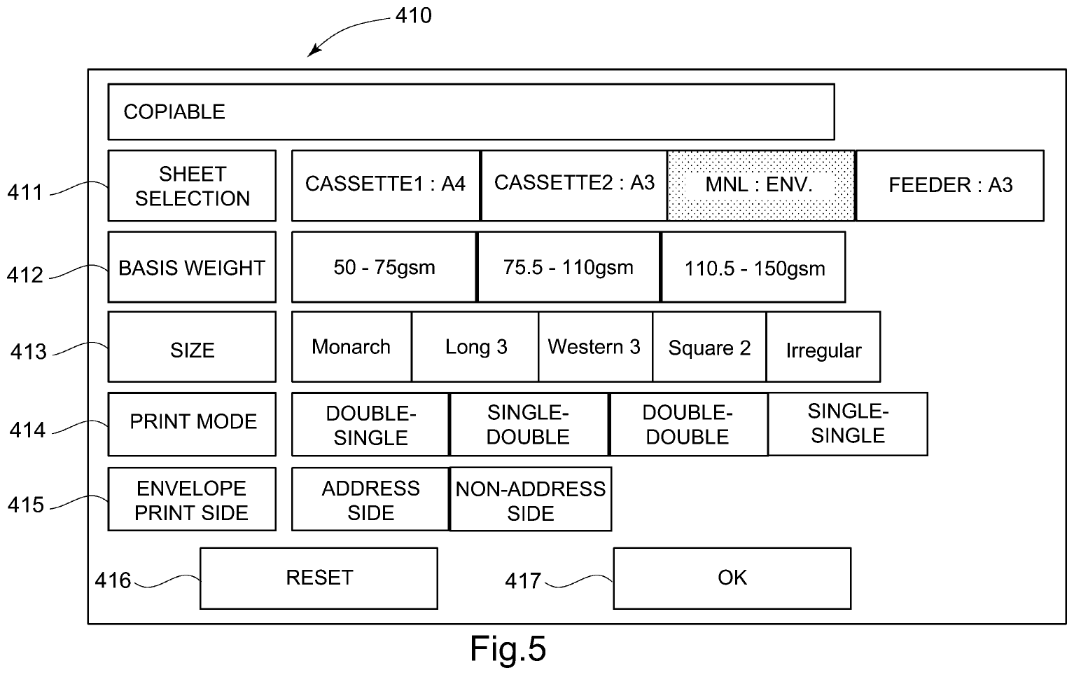

To this CPU 301, an operating portion 400 and the display portion 410 are connected via communication busses (for example, data and address busses). The operating portion 400 is, for example, an operating panel, an external terminal or the like for receiving an execution start operation, by a user, of the various programs such as the image forming job and receiving various data inputting operations by the user and the like operation. The operating portion 400 includes, as described later (FIG. 4), various operating elements such as operating keys and operating buttons through which the operating portion 400 receives user's input. The display portion 410 is capable of appropriately displaying various screens such as an input screen (FIG. 5) for inputting various data relating to the envelope S on which the image is printed. In the case of this embodiment, the operating portion 410 is a display of a so-called touch panel type in which various operating elements are displayed and input of various data by the user depending on a touch operation to the operating elements by the user. Incidentally, the display portion 410 is not limited to the display provided to the apparatus main assembly 100a, but may also be, for example, an external display connected to the apparatus main assembly 100a or a display of an external terminal such as a personal computer. Further, the display portion 410 may also be connected to the image forming apparatus 100 through cable (wire) connection or wireless connection if the display portion 410 is capable of communicating with the image forming apparatus 100.

### <Operating Portion>

FIG. 4 shows an example of the operating portion 400. As shown in FIG. 4, the operating portion 400 is provided with various operating elements such as a printer key 401, a copy mode key 402, a numeric keypad 403, a reset key 404, a stop key 405, a start key 406, and a power (on/off) switch 407. The printer key 401 is used for inputting various data relating to normal printing. The copy mode key 402 is used for inputting various data relating to copy printing in the case where the image forming apparatus 100 is used as a copying machine (copy mode). In the case where the printer key 401 or the copy mode key 402 are operated, for example, an input screen for inputting the various data is displayed at the display portion 410. The numeric keypad 403 is used for inputting information on a numerical value such as print number, for example. The reset key 404 is used for resetting inputted various data by operation of the respective keys, to initial values. The stop key 405 is used for forcedly stopping the image forming job during execution, for example. The start key 406 is used for providing on instruction to start the image forming job including a reading operation of an original image during an operation in a copy mode). The power switch 407 is used for turning on and off a power source of the image forming apparatus 100

### <Input Screen>

FIG. 5 shows an example of an input screen displayed at the display portion 410. However, in FIG. 5, the case where the image forming apparatus 100 is used as the copying machine (copy mode) was shown as an example. In order to indicate the copy mode, on the input screen shown in FIG. 5, “COPIABLE” is displayed. On this input screen, as the operating elements, a sheet selection key 411, a basis weight selection key 412, a size selection key 413, a print mode key 414, an envelope printing side selection key 415, a reset (setting release) key 416, an OK key 417 are displayed. The user is capable of selectively inputting the various data relating to the printing by using these operating elements displayed at the display portion 410. These operating keys are reverse-displayed every operation by the user. As a result, the user can know that selection of information on display contents associated with the operated operating element was made. Incidentally, the operating elements shown in FIG. 5 are an example, and are not limited thereto.

The sheet selection key 411 is used for inputting either one of the cassette 12, the manual feeding tray 11 and the stacking device 20. Either one of the cassette 12, the manual feeding tray 11 and the stacking device 20 (hereinafter, these are also referred to as stacking portions) inputted by the sheet selection key 411 is stored in the memory 302 (FIG. 3). In this example, the case where “MANUAL FEEDING TRAY: ENVELOPE” is selected for stacking the envelope S on the manual feeding tray 11 and for printing the image on the surface was shown.

The basis weight selection key 412 is used for inputting a basis weight of the envelope S. The size selection key 413 is used for inputting a size (kind) of the envelope S stacked on the stacking portion inputted by the sheet selection key 411. In this example, as the size of the envelope S stacked on the manual feeding tray 11, it is possible to input either one of “Monarch, Long 3, Western 3, Square 2, Irregular”. Incidentally, “Irregular” is inputted as the size of the envelope S, the user input an arbitrary size by using the numeric keypad 403 (FIG. 4) or the like.

The thus-selected or inputted size (kind) of the envelope S is stored as envelope information in the memory 302. In the case of this embodiment, the envelope information includes flap information indicating an open/close information of the flap of the envelope S, in addition to the kind of the envelope S subjected to the image formation. That is, in general, the envelope S is sold in a state in which the flap thereof is closed (folded) and in a state in which the flap is not closed (folded), and therefore, an open/close state of the flap is determined depending on the size (kind) of the envelope S.

However, depending on the situation, the user intends to arbitrarily close and open the flap in some instances. In such a case, although illustration is omitted, operating elements capable of selecting the open/close state of the flap are displayed on the input screen and whether the image is printed in the state in which the flap is closed or in the state in which the flap is opened can also be selected arbitrarily by the user. In that case, the flap information included in the envelope information is renewed depending on user selection. Thus, as regards the open/close state of the flap, the user may preferably use the open and close states for different purposes depending on the situation. For example, when the image is printed on the envelope S in the state in which the flap is open, during printing of the image on a non-address side (side where the flap is not formed, i.e., back side), the character (image) or the like can also be printed in a region to be hidden behind the flap in the state in which the flap is closed. On the other hand, when the image is printed on the envelope S in the flap is closed, a margin does not readily generate in a boundary between the flap and the non-address side, and therefore, a degree of overlapping of the toner image formed so as to range (span) over the flap and the non-address side is better than that in the case where the image is printed on the envelope S in the state in which the flap is opened. Depending on which state is regarded as important, the user is capable of selecting the open/close state of the flap.

The print mode key 414 is used for inputting either one of a one (single) side printing mode in which the image is printed on only one (single) side of the recording material and a double-side printing mode in which the images are printed on both sides of the recording material. The user is capable of selecting the one-side printing mode in which the images on both sides of an original are printed on one side of the recording material (“DOUBLE-SINGLE”) or in which the image on one side of the original is printed on one side of the recording material (“SINGLE-SINGLE”) and the double-side printing mode in which the image on one side of the original is printed on both sides of the recording material (“SINGLE-DOUBLE”) or in which the images on both sides of the original are printed on both sides of the recording material (“DOUBLE-DOUBLE”). The envelope printing side selection key 415 is used for selecting whether the image is printed on the address side (flap-formed side, i.e., the front side) of the envelope S or on the non-address side (the side where the flap is not formed, i.e., the back side) of the envelope S. In the case where the double-side printing of the images on the both sides of the envelope S is carried out, when the image is printed early on the side selected by the envelope printing side selection key 415, the user can easily understand the side on which the image is printed early. The reset key 416 is used for resetting (releasing) the information inputted by the operation of each of the above-described keys. The OK key 417 is used for determining the information inputted by the operation of each of above-described keys.

Returning to FIG. 3, the CPU 301 acquires various data inputted through the operating portion 400 and the display portion 410 and causes the memory 302 to store the various data. Then, for example, depending on an actuating operation such as turning-on of the power source (main switch) of the image forming apparatus 100, the CPU 301 reads the envelope printing program (FIG. 6) from the memory 302 and executes the display control program. By executing the envelope printing program, the controller 300 functions as a display controller 301a, an envelope information acquiring portion 301b as a second acquiring portion, a stacking information acquiring portion 301c, an image data acquiring portion 301d as a second acquiring portion, a data dividing portion 301e, and an image formation controller 301f.

The display controller 301a controls display at the display portion 410. As display control of the display portion 410, the display controller 301a not only causes the display portion 410 to display the above-described input screens but also carries out display control such that in the case where the double-side printing of the images on the both sides of the envelope S is carried out, a stacking method of the envelope S, the cassettes 12, the manual feeding tray 11, and the stacking device 20 is displayed at the display portion 410. The envelope information acquiring portion 301b acquires, for example, envelope information, such as the size of the envelope S, inputted at the operating portion 400 or the display portion 410 and causes the memory 302 to store the enter information. The stacking information acquiring portion 301c acquires the stacking portion information of the cassettes 12, the manual feeding tray 11, or the stacking device 20, on which the envelope S inputted at the display portion 410 is stacked, and causes the memory 302 to store the stacking portion information. The display controller 301a causes the display portion 410 to display the stacking method of the envelope S on the basis of the enter information and the stacking portion information which are acquired by the enter information acquiring portion 301b and the stacking portion information acquiring portion 301c, respectively.

The image data acquiring portion 301d acquires image data sent from the original reading device (not shown) or the external terminal and causes the memory 302 to store the image data. The CPU 301 is capable of controlling the operation of the image forming apparatus 100 during the image forming job so that the image formation is carried out using the acquired image data.

The data dividing portion 301e divides the image data acquired by the image data acquiring portion 301d and data of the toner image printed over the flap in order to carry out printing of the image over the flap closed and the non-flap portion of the envelope S in the state in which the flap is not closed. Specifically, the image data of the toner image printed over the flap is divided into first data of a first toner image printed on the flap in the open state and second data of a second toner image printed on a portion other than the flap. The first toner image is a part of the toner image based on the image data before the division, and the second toner image is a remaining part of the toner image based on the image data before the division.

The image formation controller 301f controls the operation of the image forming apparatus 100 on the basis of the image data acquired by the image data acquiring portion 301d and the first data and the second data obtained by dividing the toner image data by the data dividing portion 301e, in order to execute the formation of the image on the envelope S. The image formation controller 301f forms the first toner image on the flap on the basis of the first data when the image is formed on the address side of the envelope S with the flap which is not closed, and forms the second toner image on the non-address side of the envelope S on the basis of the second data when the image is formed on the non-address side of the envelope S.

### <Printing Process>

The printing process in this embodiment will be described using FIG. 6 with reference to FIGS. 3 to 5. The printing process in this embodiment is started by the controller 300, for example, in the case where the printer key 401 or the copy mode key 402 of the operating portion 400 is operated by the user, and is ended in response to an end of an image forming job started by an operation of the start key 406 of the operating portion 400.

The controller 300 causes the display portion 410 to display the above-described input screen (FIG. 5) or the like and receives user input through the displayed input screen (S1). In response to the user input, the controller 300 is capable of acquiring envelope information as a procedure of acquiring the flap information by the envelope information acquiring portion 301b and of acquiring stacking portion information by the stacking information acquiring portion 301c (S2). The controller 300 discriminates whether or not the recording material subjected to printing is the envelope (S3). In the case where the recording material is not the envelope S (NO of S3), the controller 300 causes the process to jump to step S6. On the other hand, in the case where the recording material is the envelope S (YES of S3), the controller 300 discriminates whether or not the envelope S subjected to the printing is a regular envelope (S4). In the case where the envelope S is not the regular envelope (NO of S4), the controller 300 acquires the size (inputted size information) of the envelope S inputted by an operation of the numeric keypad 403 (S5), the inputted size information acquired is stored as partial data of the envelope information in the memory 302.

The controller 300 causes the display portion 410 to display an “envelope stacking method” including envelope images (parts (a) and (b) of FIG. 7) described later (S6). At this time, in the case where printing of the image on the address side of the envelope S is selected by the envelope printing side selection key 415, the “stacking method during address side printing” is displayed at the display portion 410. In the case where printing of the image on the non-address side of the envelope S is selected by the envelope printing side selection key 415, the “stacking method during non-address side printing” is displayed at the display portion 410.

### <Display Example of Envelope Stacking Method>

As an example, in the case where an envelope S with a flap Sa on the short side (for example, Square 2) is stacked on the manual feeding tray 11, a display example of the “stacking method during address side printing” regarding flap printing is shown in part (a) of FIG. 7, and a display example of the “stacking method during non-address side printing” is shown in part (b) of FIG. 7. In the case of this embodiment, the stacking method of the envelope S is displayed at the display portion 410 by character information for illustrating the envelope stacking method with characters and by image information represented by an envelope image including an orientation of the flap Sa of the envelope S and the front and back of the envelope S. Incidentally, also in the case of the envelope S with the flap Sa on the long side (for example, Western 3), similar display may also be employed. Further, in the case of the envelope S with the flap Sa on the long side, display such that the envelope S is stacked along a direction in which the flap Sa crosses a feeding direction of the envelope S may also be made.

As shown in part (a) of FIG. 7, in the case where printing of the image on the address side of the envelope S stacked on the manual feeding tray 11 is selected, the stacking method of the envelope S is displayed so that the address side (the side where the flap Sa is formed) faces upward in the open state of the flap Sa. On the other hand, as shown in part (b) of FIG. 7, in the case where printing of the image on the non-address side of the envelope S stacked on the manual feeding tray 11 is selected, the stacking method of the envelope S is displayed so that the non-address side (the side where the flap Sa is not formed) faces upward in the closed state of the flap Sa. Incidentally, in this case, the example in which the envelope image is displayed so that the closed short side (non-flap side) with no flap Sa is on that trailing end side with respect to the feeding direction was described, but the envelope image may also be displayed so that the non-flap surface is on the leading end side with respect to the feeding direction.

Incidentally, in the case where printing of the image on the address side of the envelope S stacked in the stacking device 20 is selected, the same display as the display of the “stacking method during address side printing” shown in part (a) of FIG. 7, i.e., the stacking method in which the address side of the envelope S is the upper surface side is displayed. Further, in the case where printing of the image on the non-address side of the envelope S stacked in the stacking device 20 is selected, the same display as the display of the “stacking method during non-address side printing” shown in part (b) of FIG. 7, i.e., the stacking method in which the non-address side of the envelope S is the upper surface side is displayed. On the other hand, in the case where printing of the image on the address side of the envelope S stacked in the cassette 12 is selected, although illustration is omitted, the stacking method in which the non-address side of the envelope S is the upper surface side in the state in which the flap Sa is open. Further, in the case where printing of the image on the non-address side of the envelope S stacked in the cassette 12 is selected, although illustration is omitted, the stacking method in which the address side of the envelope S is the upper surface side in the state in which the flap Sa is closed. This is because as described above, the envelope S on the manual feeding tray 11 or in the stacking device 20 is fed to the secondary transfer portion T2 in a state in which the front and back of the envelope S is kept in the stacked state, but the envelope S in the cassette 12 is fed to the secondary transfer in a state in which the front and back of the envelope S is in a state reverse to the stacked state. The display of the stacking method which can vary depending on the above-described stacking portion is made on the basis of the stacking portion information acquired by the stacking information acquiring portion 301c.

Further, in the case where the stacking method is displayed so that the flap Sa extends along the direction crossing the feeding direction of the envelope S, as shown in parts (a) and (b) of FIG. 7, when the stacking method is displayed so that the short side (flap side) on which the flap Sa exists is the trailing end side with respect to the feeding direction, envelope crease can be prevented, so that such display is preferred.

Returning to description of FIG. 6, the controller 300 discriminates whether or not a start of the image forming job is instructed by an operation of the start key 406 by the user (S7). In the case where the start of the image forming job is not instructed (NO of S7), the controller 300 repeats processes of S1 to S6 described above. In the case where the start of the image forming job is instructed (YES of S7), the controller 300 acquires, as a procedure in which the image data acquiring portion 301d acquires the image data of the toner image, the image data from the original reading device (not shown) or the external terminal and then causes the memory 302 to store the image data (S8).

After the image data is acquired, the controller 300 discriminates whether or not the printing is printing of the image on the envelope in the state in which the flap is open, on the basis of the flap information (S9). In the case where the printing is not the printing of the image on the envelope in the open state of the flap (NO of S9), the controller 300 causes the process to jump to a process of S11. On the other hand, in the case where the printing is the printing of the image on the envelope in the open state of the flap (YES of S9), the controller 300 executes a procedure in which the image data (S8) acquired by the data dividing portion 301e is divided into two divided data (S10). That is, of the acquired image data when the image data of the toner image to be printed while ranging between the flap Sa closed and the non-address side exists, the image data is divided. As described above, the image data of the toner image ranging between the flap Sa closed and the non-address side is divided by the data dividing portion 301e into first data of a first toner image to be printed on the flap Sa in an open state and second data of a second toner image to be printed on a portion other than the flap Sa.

The controller 300 discriminates whether or not the image should be printed on the flap Sa, on the basis of the image data acquired from the original reading device (not shown) or the external terminal or the like, specifically whether or not the toner image should be printed so as to range between the closed flap Sa and the non-address side, on the basis of the acquired image data (S11). As an example, to the image data acquired from the original reading device (not shown) or the external terminal or the like, positional information indicating a print position on the envelope S is provided, and on the basis of this print position, discrimination can be made depending on whether or not there is a toner image to be printed so as to range between the closed flap Sa and the non-address side. In the case where the image is not printed on the flap Sa (NO of S11), the controller 300 executes, as a normal printing process, image formation by the image formation controller 301f on the basis of the image data which has already been stored in the memory 302 (S13). In this case, there is no image data to be printed on the flap Sa, and therefore there are no image data and second data which are described above. Accordingly, no image is printed on the flap Sa.

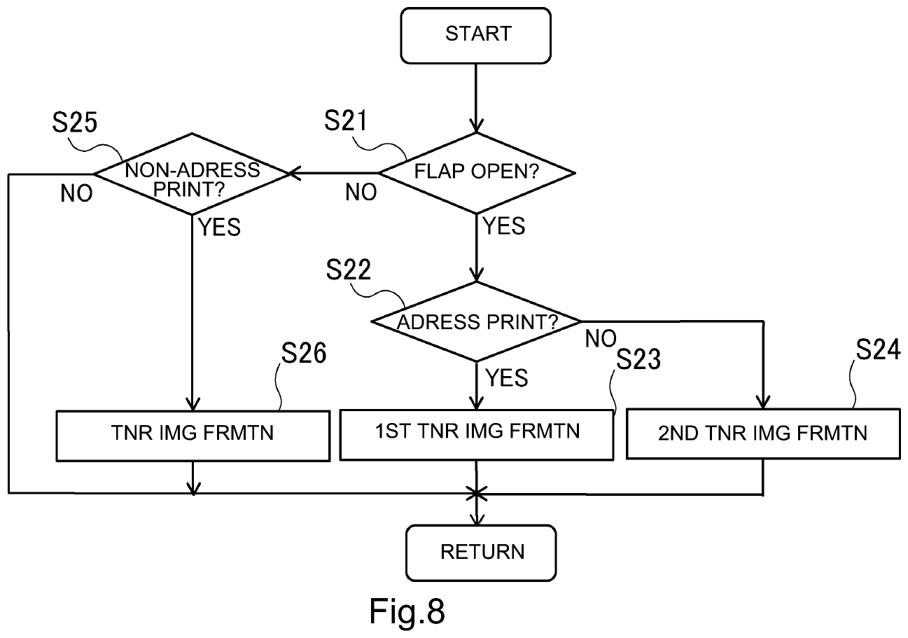

On the other hand, in the case of printing the image on the flap Sa (YES of S11), the controller 300 carried out a flap printing process. The flap printing process will be described later (FIG. 8). Then, the controller 300 discriminates whether or not the image forming job during execution is ended (S14). In the case where the image forming job is ended (YES of S14), the controller 300 ends this printing process. On the other hand, in the case where the image forming job is not ended (NO of S14), the controller 300 repeats the above-described processes S11 to S13.

### <Flap Printing Process>

Next, the flap printing process (S12 of FIG. 6) in this embodiment will be described using FIG. 8 while making reference to FIGS. 3 and 5. Here, for easy understanding of description, image formation of the toner image ranging between the flap Sa in the closed state and the non-address side will be described, and other image formations of toner images to be printed on the address side and/or the non-address side will be omitted from description. A constitution in which image formation of an address on the address side or formation of the image on the non-address side is carried out together with the image formation of the toner image ranging between the flap Sa in the closed state and the non-address side may also be employed.

As shown in FIG. 8, on the basis of the above-described flap information showing the open/close state of the flap Sa of the envelope S, the controller 300 discriminates whether or not the flap Sa of the envelope S to be subjected to printing is in an open state (S21). In the case where the flap Sa of the envelope S is in the open state (YES of S21), the controller 300 discriminates whether or not the printing of the toner image on the address side of the envelope S is selected by the envelope printing side selection key 415 (S22).

In the case where the printing of the toner image on the address side of the envelopes is selected (YES of S22), the controller 300 executes, as a procedure of forming the first toner image on the basis of the first data by the image formation controller 301f, image formation of the first toner image on the flap Sa in the open state (S23). On the other hand, in the case where the printing of the toner image on the non-address side of the envelopes, not the printing of the toner image on the address side of the envelope S is selected (NO of S22), the controller 300 executes, as a procedure of forming the second toner image on the basis of the second data by the image formation controller 301f, image formation of the second toner image on the non-address side (S24). The controller 300 returns to the above-described printing process (FIG. 6) after performing the process of S23 or S24.

In S21, the case where the flap Sa of the envelope S is in the closed state (NO of S21), the controller 300 discriminates whether or not the printing of the toner image on the non-address side of the envelope S is selected by the envelope printing side selection key 415 (S25).

In the case where the printing of the toner image on the non-address side of the envelopes is selected (YES of S25), in the controller 300, the image formation controller 301f executes, on the basis of image data stored in the memory 302 and before the division, image formation of the toner image ranging between the flap Sa in the closed state and the non-address side (S26). On the other hand, in the case where the printing of the toner image on the address side of the envelope S, not the printing of the toner image on the non-address side of the envelope S is selected (NO of S25), the controller 300 does not execute image formation of the toner image on the address side, and returns to the above-described printing process (FIG. 6).

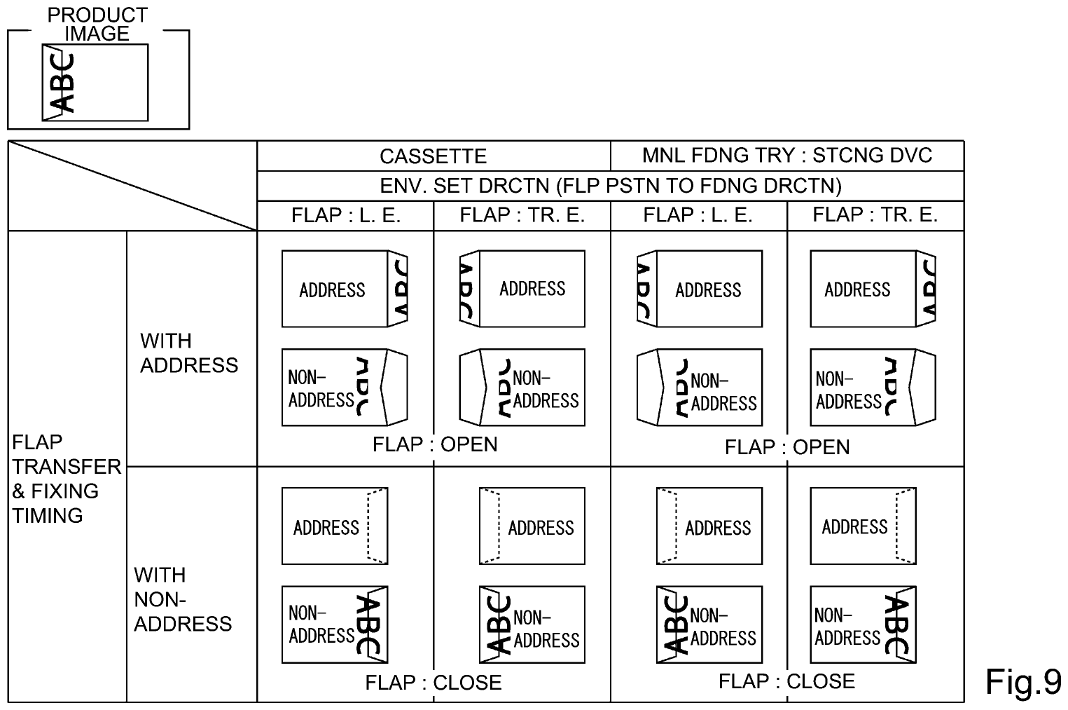

In FIG. 9, a print state in the case where a toner image (English characters “ABC”) is shown by being divided into the case where printing of the toner image on the flap is performed during printing of the image on the address side and the case where the toner image on the flap is performed during printing of the image on the non-address side. As shown in FIG. 9, in the case where the toner image is printed on the flap in the state in which the flap is opened, the toner image which will range between the flap and the non-address side is printed as separate toner images (first toner image and second toner image) during address side printing and during non-address side printing in a manner such that the toner image is divided at a boundary between the flap and the non-address side (first image forming mode). In this case, orientations of the toner images (first toner image and second toner image) are opposite to each other. On the other hand, in the case where the toner image is printed on the flap in the closed state, the toner image ranging between the flap and the non-address side is printed as a single toner image during the non-address side printing (second image forming mode).

As described above, in this embodiment, as regards the envelope S in the state in which the flap is open, image formation of the first toner image on the flap in the open state is carried out during the address side printing on the basis of the first data, and image formation of the second toner image on the non-address side is carried out during the non-address side printing on the basis of the second data. Thus, the toner image which will range between the flap in the closed state and the non-address side when the flap is closed was formed. Further, as regards the envelope S in the state in which the flap is closed, during the non-address side printing, the toner image ranging between the flap in the closed state and the non-address side is formed. As a result, improper fixing resulting from a difference in nip pressure during the fixing due to a difference in thickness generating between an overlapping portion (flap portion) with the closed flap and a non-overlapping portion (non-flap portion) with the flap can be suppressed. Accordingly, it is possible to provide the image forming apparatus in which the printing of the toner image on the flap of the envelope S, particularly the printing of the toner image ranging between the closed flap and the non-flap portion is capable of being properly carried out.

### Another Embodiment

Incidentally, in the above-described embodiment, the image forming apparatus having the constitution in which the toner images of the respective colors are primary-transferred from the photosensitive drums 1Y to 1K for the colors onto the intermediary transfer belt 8, and then the composite toner images are collectively secondary-transferred onto the envelope S was described, but the present invention is not limited thereto. For example, an image forming apparatus of a direct transfer type in which the toner images are directly transferred from the photosensitive drums 1Y to 1K onto the envelope S may also be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-210760 filed on Nov. 8, 2018 which is hereby incorporated by reference herein in its entirety.

What is claimed is:

1. An image forming apparatus comprising:
a stacking portion configured to stack an envelope;
an image forming portion configured to form a toner image on the envelope fed from said stacking portion;
an acquiring portion configured to acquire image data ranging between a flap closed and a non-address side; and
an executing portion capable of executing, on the basis of the image data acquired by said acquiring portion, an operation in a first image forming mode in which an image is formed on the envelope stacked on said stacking portion in a state in which said flap is open,
wherein the executing portion forms an image ranging between said flap closed and the non-address side by automatically reversing and feeding the envelope to form an image on said flap on an address side and to form an image on the non-address side.

2. An image forming apparatus according to claim 1, wherein said executing portion is capable of executing, on the basis of the image data acquired by said acquiring portion, an operation in a second image forming mode in which the image ranging between said flap closed and the non-address side is formed on the envelope stacked on said stacking portion in a state in which said flap is closed.

3. An image forming apparatus according to claim 2, further comprising,
a display portion configured to display information, and
a controller configured to cause said display portion to display a screen for selecting the first image forming mode and the second image forming mode, at said display portion.

4. An image forming apparatus according to claim 2, further comprising,
a display portion configured to display information, and
a controller configured to cause said display portion to display, when a user selects the first image forming mode, an image of the envelope which is stacked on said stacking portion and which is in a state in which said flap is open, at said display portion.

5. An image forming apparatus according to claim 2, further comprising,
a display portion configured to display information, and
a controller configured to cause said display portion to display, when a user selects the second image forming mode, an image of the envelope which is stacked on said stacking portion and which is in a state in which said flap is closed, at said display portion.

6. An image forming apparatus according to claim 1, wherein said executing portion is capable of forming an image of an address on an address side of the envelope in the operation in the first image forming mode.

7. An image forming apparatus according to claim 1, wherein said executing portion is capable of forming an image of an address on an address side of the envelope in the operation in the second image forming mode.

8. An image forming apparatus according to claim 1, wherein said stacking portion is a cassette.

9. An image forming apparatus according to claim 1, wherein said stacking portion is a manual feeding tray.
